(19) United States
(12) Patent Application Publication
(10) Pub. No.: US 2011/0050027 A1
(43) Pub. Date: Mar. 3, 2011

(54) Motor Rotor

(76) Inventor: Alex Horng, Lingya Dist (TW)

(21) Appl. No.: 12/549,440

(22) Filed: Aug. 28, 2009

(51) Int. Cl. H02K 1/27

(52) U.S. Cl. 310/216.066

(57) ABSTRACT

A motor rotor includes a magnetically conducting member having an inner periphery and an outer periphery spaced from the inner periphery in a radial direction. The magnetically conducting member further includes first and second ends spaced along an axis perpendicular to the radial direction. The magnetically conducting member includes a reinforcing portion extending from the first end in the radial direction. A rotatable member is formed by injection molding and embraces and engages the outer periphery of the magnetically conducting member. The rotatable member includes an opening receiving the first end of the magnetically conducting member and is rotatable about the axis. A permanent magnet is coupled to the inner periphery of the magnetically conducting member. The reinforcing portion reinforces the first end of the magnetically conducting member, which is useful during injection molding of the rotatable member.

### BACKGROUND OF THE INVENTION

1. Field of the Invention

The present invention relates to a motor rotor and, more particularly, to a motor rotor suitable to be formed by injection molding.

2. Description of the Related Art

FIGS. 1 and 2 show a conventional motor rotor 8 including a hub 81, a metal ring 82, and an annular magnet 83. The metal ring 82 is formed by bending a metal strip having a length equal to or slightly smaller than a circumference of an inner periphery of the hub 81. The metal ring 82 is mounted to and presses against the inner periphery of the hub 81 with two ends of the metal ring 82 in contact with or slightly spaced from each other. The annular magnet 83 is force-fitted to an inner periphery of the metal ring 82. An example of such a motor rotor is disclosed in Taiwan Publication No. 490912. Since the metal ring 82 only presses against the inner periphery of the hub 81 in a radial direction and since the ends of the metal ring 82 are not positioned, the engagement between the hub 81 and the metal ring 82 is not reliable.

FIG. 3 shows another conventional motor rotor 9 including a hub 91, a metal ring 92, and a permanent magnet 93. The hub 91 includes an opening 911 and is formed by injection molding to embrace the metal ring 92. The metal ring 92 includes a first end 921 facing the opening 911 and a second end 922 spaced from the first end 921 along an axis about which the motor rotor 9 rotates. The permanent magnet 93 is coupled to the inner periphery of the metal ring 92 that provides magnetically conducting effect for the permanent magnet 93. By such an arrangement, the hub 91 embraces and engages with the metal ring 92 to provide enhanced engaging effect. However, the metal ring 92 is liable to deform when it is fixed by a jig in a cavity of a mold for injection molding of the hub 91 in which the metal ring 92 is embedded. This is because the first end 921 of the metal ring 92 is not reinforced. The metal ring 92 can not maintain a true circle due to deformation of the first end 921, adversely affecting the quality of the motor rotor 9 formed after injection molding and reducing rotational stability of the motor rotor 9. Furthermore, the structure of the first end 921 of the metal ring 92 does not allow the first end 921 and the whole metal ring 92 to be easily placed in the cavity of the mold. Embedding of the metal ring 92 becomes more difficult if the metal ring 92 deforms during placing of the metal ring 92 in the cavity of the mold. Further, the first end 921 of the metal ring 92 does not provide any structure for guiding the permanent magnet 93 when coupling the permanent magnet 93 with the metal ring 92. Thus, assembly of the permanent magnet 93 and the metal ring 92 is not easy, and deformation may occur during assembly. Further, if the metal ring 92 deforms during the injection molding process, the permanent magnet 93 will not be in intimate contact with the metal ring 92 or even unable to couple with the metal ring 92.

### SUMMARY OF THE INVENTION

An objective of the present invention is to provide a motor rotor including a magnetically conducting member with improved structural strength for injection molding.

Another objective of the present invention is to provide a motor rotor including a magnetically conducting member that is less likely to deform during injection molding.

A further objective of the present invention is to provide a motor rotor including a magnetically conducting member allowing easy assembly.

Still another objective of the present invention is to provide a motor rotor with a magnetically conducting member to increase rotational stability of a motor utilizing the motor rotor.

A motor rotor according to the preferred teachings of the present invention includes a magnetically conducting member having an inner periphery and an outer periphery spaced from the inner periphery in a radial direction. The magnetically conducting member further includes first and second ends spaced along an axis perpendicular to the radial direction. The magnetically conducting member includes a reinforcing portion extending from the first end in the radial direction. A rotatable member is formed by injection molding and embraces and engages the outer periphery of the magnetically conducting member. The rotatable member includes an opening receiving the first end of the magnetically conducting member. The rotatable member is adapted to rotate about the axis. A permanent magnet is coupled to the inner periphery of the magnetically conducting member.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows an exploded, perspective view of a conventional motor rotor.

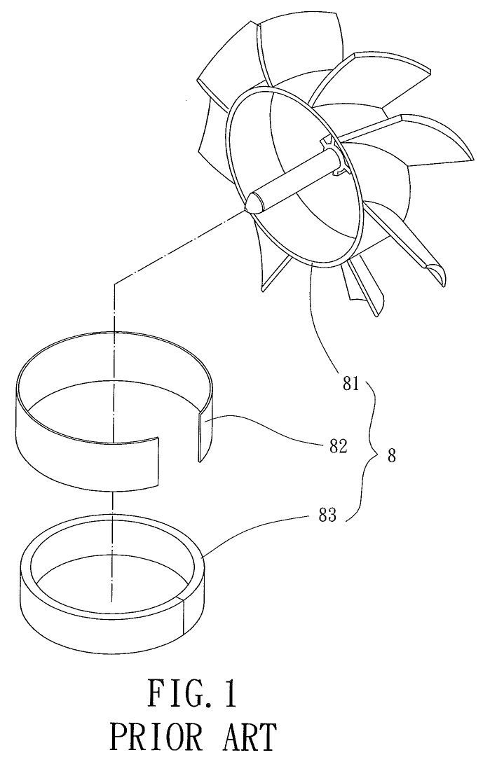

FIG. 2 shows another exploded, perspective view of the motor rotor of FIG. 1 with a metal ring mounted in a hub and with portions broken away.

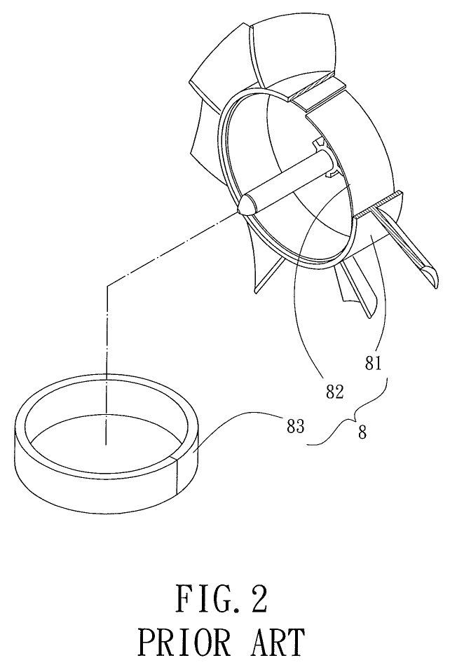

FIG. 3 shows a cross sectional view of another conventional motor rotor.

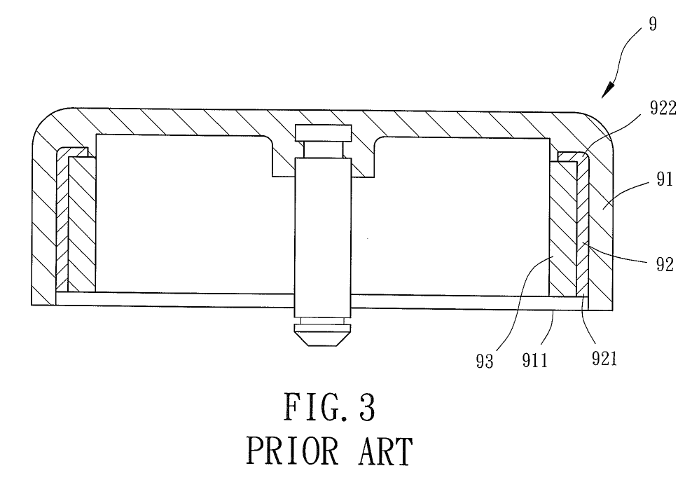

FIG. 4 shows a cross sectional view of a motor rotor of a first embodiment according to the preferred teachings of the present invention.

FIG. 5 shows a perspective view of a magnetically conducting member of the motor rotor of FIG. 4 with portions broken away.

FIG. 6 shows a cross sectional view of a motor rotor of a second embodiment according to the preferred teachings of the present invention.

FIG. 7 shows an exploded, cross sectional view illustrating assembly of the motor rotor of FIG. 4.

FIG. 8 shows a cross sectional view of a motor utilizing the motor rotor of FIG. 4.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “end”, “portion”, “section”, “radial”, “circumferential”, “annular”, “outward”, “inward”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

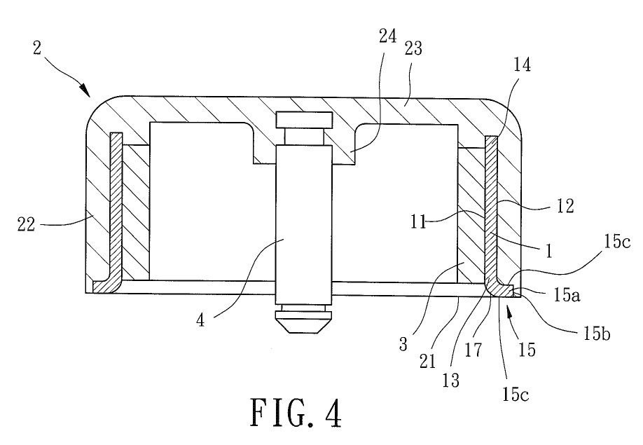

A motor rotor according to the preferred teachings of the present invention is shown in FIGS. 4-7 and includes a magnetically conducting member 1, a rotatable member 2, and a permanent magnet 3. The magnetically conducting member 1 is made from metal capable of providing magnetically conducting effect. The rotatable member 2 embraces the magnetically conducting member 1 to which the permanent magnet 3 is engaged. The magnetically conducting member 1 is intermediate the rotatable member 2 and the permanent magnet 3 to provide the magnetically conducting effect for the permanent magnet 2.

The magnetically conducting member 1 is an annular ring including an inner periphery 11 and an outer periphery 12 spaced from the inner periphery 11 in a radial direction perpendicular to an axis about which the rotatable member 2 rotates. The annular ring further includes first and second ends 13 and 14 spaced along the axis. The magnetically conducting member 1 further includes a reinforcing portion 15 extending in the radial direction to reinforce the first end 13 for avoiding deformation of the magnetically conducting member 1.

The rotatable member 2 is formed by injection molding to embrace and engage the magnetically conducting member 1 as a single piece, so that the rotatable member 2 firmly and intimately engages with the outer periphery 12 of the magnetically conducting member 1. The rotatable member 2 includes an opening 21 receiving the first end 13 of the magnetically conducting member 1.

The permanent magnet 3 can be an annular magnet formed of a plastic magnet, a rubber magnet, or a magnet made of other suitable material. The permanent magnet 3 is coupled to the inner periphery 11 of the magnetically conducting member 1.

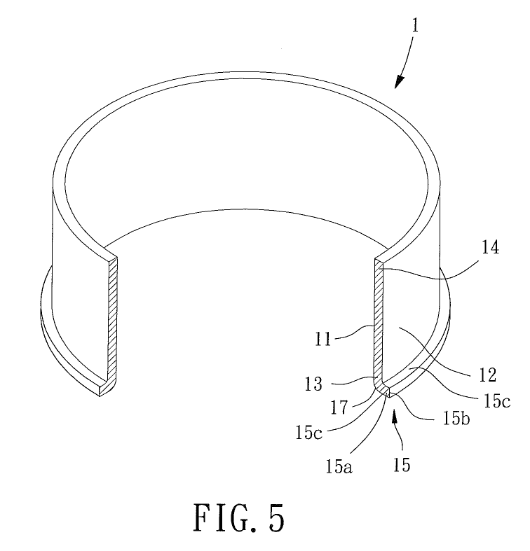

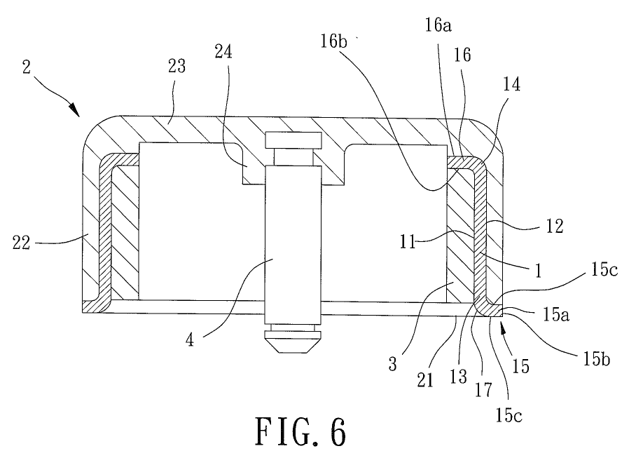

In the preferred forms shown in FIGS. 4-6, the reinforcing portion 15 includes an annular flange 15a extending outward from the outer periphery 12 of the magnetically conducting member 1 in the radial direction. The annular flange 15a includes inner and outer annular faces 15c spaced along the axis and a circumferential end face 15b extending between the inner and outer annular faces 15c. When the rotatable member 2 integrally embraces the magnetically conducting member 1, the rotatable member 2 can firmly and intimately engage with the outer periphery 12 and the annular flange 15a. The engaging strength between the magnetically conducting member 1 and the rotatable member 2 is, thus, enhanced. The rotatable member 2 also embraces and firmly engages with the circumferential end face 15b, the outer annular face 15c, and a portion of the inner periphery 11 at the second end 14 of the magnetically conducting member 1 in the preferred form shown in FIGS. 4 and 5. In the preferred form shown in FIG. 6, the second end 14 of the magnetically conducting member 1 includes an extension 16 extending inward from the inner periphery 11 in the radial direction and spaced from the annular flange 15a along the axis. The extension 16 includes inner and outer surfaces 16a and 16b spaced along the axis. The inner surface 16b is intermediate the outer surface 16a and the reinforcing portion 15 of the magnetically conducting member 1. The rotatable member 2 also embraces and firmly engages with the outer surface 16a and the outer annular face 15c to enhance the engaging strength between the rotatable member 2 and the magnetically conducting member 1.

In the preferred forms shown in FIGS. 4-6, the rotating member 2 includes an annular wall 22 and a sealing portion 23 formed on and sealing an end of the annular wall 22. The opening 21 is formed in the other end of the annular wall 22. A hub is, thus, formed. The sealing portion 23 includes a shaft coupling portion 24 located in a central portion of the sealing portion 23. The opening 21 and the shaft coupling portion 24 are located at two sides of the rotatable member 2 with the opening 21 spaced from the shaft coupling portion 24 along the axis.

The rotatable member 2 can further include a plurality of blades formed on the outer periphery of the rotatable member 2, so that the rotatable member 2 can be utilized as an impeller of a heat dissipating fan.

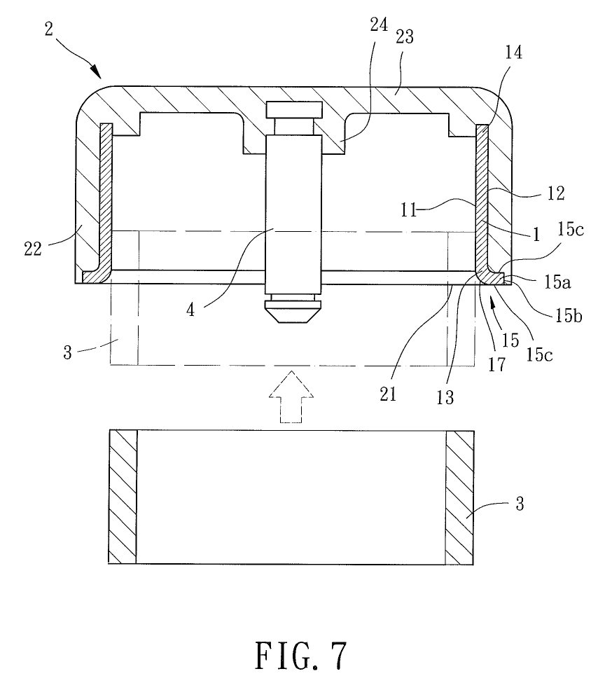

In the preferred forms shown in FIGS. 4-6, a guiding section 17 is formed at an intersection of the reinforcing portion 15 and the first end 13 of the magnetically conducting member 1. The guiding section 17 can be a rounded corner or a beveled face in cross section or any other suitable provisions for guiding the permanent magnet 3. When coupling the permanent magnet 3 with the magnetically conducting member 1, the guiding section 17 guides the permanent magnet 3, allowing easy engagement between the permanent magnet 3 and the magnetically conducting member 1, as shown in FIG. 7. In the preferred form shown in FIGS. 4 and 5, the permanent magnet 3 engages with the inner periphery 11 of the magnetically conducting member 1 and abuts a portion of the rotatable member 2 embracing the portion of the inner periphery 11 at the second end 14 of the magnetically conducting member 1. In the preferred form shown in FIG. 6, the permanent magnet 3 engages with the inner periphery 11 of the magnetically conducting member 1 and abuts the inner face 16b of the extension 16.

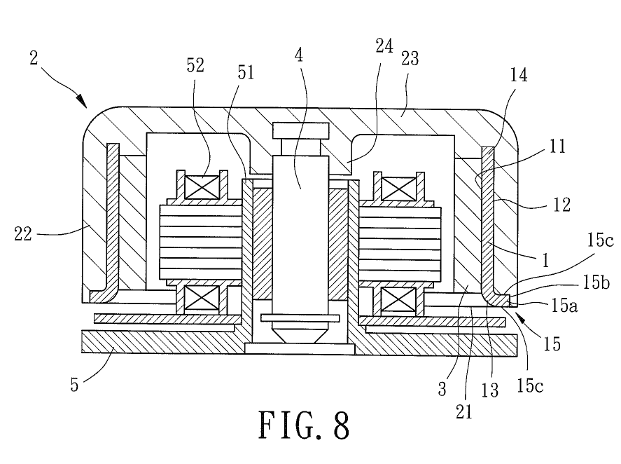

With reference to FIG. 8, in use, a shaft 4 is coupled to the shaft coupling portion 24 of the rotatable member 2 and engaged with a shaft tube 51 on a base 5 to which a stator 52 is mounted. The rotatable member 2 is rotatably coupled with the shaft tube 51 by the shaft 4 with the permanent magnet 3 aligned with the stator 52. The stator 52 magnetically interacts with the permanent magnet 3 to drive the rotatable member 2 to rotate.

The first end 13 of the magnetically conducting member 1 according to the preferred teachings of the present invention is reinforced due to provision of the reinforcing portion 15, allowing easy and smooth injection molding of the rotatable member 2. Specifically, when the magnetically conducting member 1 is fixed by a jig in a cavity of a mold for injection molding of the rotatable member 2, deformation of the first end 13 of the magnetically conducting member 1 can be avoided. This is because the magnetically conducting member 1 with the reinforcing portion 15 can be fixed in the predetermined location in the cavity of the mold. The reinforcing portion 15 also prevents deformation of the motor rotor according to the preferred teachings of the present invention during transport. Furthermore, the magnetically conducting member 1 can maintain a true circle, allowing easy, firm, and intimate engagement between the permanent magnet 3 and the magnetically conducting member 1. Assembling convenience is, thus, enhanced. Further, a motor utilizing the motor rotor according to the preferred teachings of the present invention capable of maintaining a true circle has enhanced rotational stability.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A motor rotor comprising:
a magnetically conducting member including an inner periphery and an outer periphery spaced from the inner periphery in a radial direction, with the magnetically conducting member further including first and second ends spaced along an axis perpendicular to the radial direction, with the magnetically conducting member including a reinforcing portion extending from the first end in the radial direction;
a rotatable member formed by injection molding and embracing and engaging the outer periphery of the magnetically conducting member, with the rotatable member including an opening receiving the first end of the magnetically conducting member, with the rotatable member adapted to rotate about the axis; and
a permanent magnet coupled to the inner periphery of the magnetically conducting member.

2. The motor rotor as claimed in claim 1, with the magnetically conducting member further including a guiding section at an intersection of the reinforcing portion and the first end of the magnetically conducting member.

3. The motor rotor as claimed in claim 2, with the guiding section including a rounded corner or a beveled face in cross section.

4. The motor rotor as claimed in claim 1, with the reinforcing portion including an annular flange extending outward from the outer periphery of the magnetically conducting member in the radial direction, and with the rotatable member integrally embracing the outer periphery of the magnetically conducting member and the annular flange.

5. The motor rotor as claimed in claim 1, with the second end of the magnetically conducting member further including an extension extending from the inner periphery of the magnetically conducting member in the radial direction, with the rotatable member integrally embracing the extension.

6. The motor rotor as claimed in claim 4, with the second end of the magnetically conducting member further including an extension extending from the inner periphery of the magnetically conducting member in the radial direction, with the rotatable member integrally embracing the extension.

7. The motor rotor as claimed in claim 1, with the rotatable member including an annular wall and a sealing portion formed on and sealing a side of the annular wall, with the opening formed in another side of the annular wall, with the sealing portion including a shaft coupling portion in a central portion of the annular wall, and with the shaft coupling portion adapted to couple with a shaft rotatable about the axis.

8. The motor rotor as claimed in claim 6, with the rotatable member including an annular wall and a sealing portion formed on and sealing a side of the annular wall, with the opening formed in another side of the annular wall, with the sealing portion including a shaft coupling portion in the annular wall, and with the shaft coupling portion adapted to couple with a shaft rotatable about the axis.

9. The motor rotor as claimed in claim 1, with the rotatable member further including a plurality of blades formed on an outer periphery of the rotatable member.

10. The motor rotor as claimed in claim 4, with the annular flange including inner and outer annular faces spaced along the axis, with the annular flange further including a circumferential face extending between the inner and outer annular faces, and with the rotatable member embracing and engaging the circumferential face and the outer annular face.

11. The motor rotor as claimed in claim 5, with the extension including inner and outer surfaces spaced along the axis, with the inner surface intermediate the outer surface and the reinforcing portion of the magnetically conducting member, and with the rotatable member embracing and engaging with the outer surface.
